(19) United States
(12) Patent Application Publication
(10) Pub. No.: US 2004/0127318 A1
(43) Pub. Date: Jul. 1, 2004

(54) Chain tensing device for an engine gear

(75) Inventors: Michael Yu, Tainan Hsien (TW); Ming-Chieh Wu, Tainan Hsien (TW)

Correspondence Address: BACON & THOMAS, PLLC, 625 SLATERS LANE, FOURTH FLOOR, ALEXANDRIA, VA, 22314

(73) Assignee: Aeon Motor Co., Ltd., Tainan Hsien (TW)

(21) Appl. No.: 10/329,348

(22) Filed: Dec. 27, 2002

(51) Int. Cl. F16H 7/12

(52) U.S. Cl. 474/134

(57) ABSTRACT

A chain-tensing device for an engine gear includes a nearly L-shaped connect arm and a pair of tensing rollers. The connect arm has three connect ends, a first connect end having a torque spring functioning as a buffer for the connect arm, a second and third connect ends respectively connected pivotally with an upper tensing roller and a lower tensing roller. The first connect end is pivotally fixed on a vehicle body, and the second and the third connect ends extend toward the chain so that the upper and the lower tensing roller may push the upper and the lower portion of the chain to always force the chain in a tense condition regardless of any condition of a road the vehicle may run on, and then the chain is always prevented from falling off gears the chain extends around.

### BACKGROUND OF THE INVENTION

This invention relates to a chain tensing device for an engine gear, particularly to one possible to keep always tense a chain extending around a main gear connected with an engine and a subordinate gear in any condition of a road the vehicle may run on so that the chain may not fall off the main gear and the subordinate gear owing to vibrations.

A common vehicle used for agricultural transportation and communications usually has a main gear connected to the engine of the vehicle and a subordinate gear with a chain extending around the main gear and the subordinate gear. In order to prevent the chain from sagging down owing to the gravitational force, or slacking due to a long time of use, or falling off the gears, a chain-tensing device is usually used for keeping the chain tense continuously. FIG. 1 shows a conventional chain tensing device for an engine gear, including a main gear 10 connected to the engine of a vehicle, a subordinate gear 20 supported by an end of a hanging arm 201, a shock absorber 202 provided above the subordinate gear 20, a chain 30 extending around the main gear 10 and the subordinate gear 20, and a pair of tension rollers—an upper one and a lower one 40 and 50 as main components combined together.

As the subordinate gear 20 is provided on a vehicle body with the hanging arm 201, it will be pressed down by the shock absorber 201 and the lower tensing roller 50 pushes the chain 30 up from under so as to keep the chain tense. Nevertheless, the subordinate gear 20 is connected with one end of the hanging arm 201, so when the vehicle vibrates up and down because of a rough uneven road to give rise to vibration of the subordinate gear 20, the upper and the lower tensing roller 40 and 50 may not completely touch on the chain 30 as shown in FIG. 2 or only the upper roller 40 pushes down the chain 30, as shown in FIG. 3. In other words, the conventional chain tensing device just described can only keep tense one side of the chain 30 (or even completely not pushes the chain 30), having a drawback of not surely or always keep tense the chain 30. Moreover, in order to prevent the chain 30 from falling off the main gear 10 when the main gear 10 reduces speed or reverts rotation to cause disappearance of the pulling force, a position limiting plate 301 is respectively provided at two sides of the chain 30 for restricting the chain 30 as shown in FIG. 4. Then this generates inconvenience in manufacturing and elevates the cost.

### SUMMARY OF THE INVENTION

This invention has been devised to offer a chain-tensing device for an engine gear possible to keep the chain always tense, regardless of any condition of a road the vehicle may run on, and prevent the chain from falling off the gears.

The main feature of the invention is a nearly-L-shaped connect arm combined with two tensing rollers. The connect arm has three connect ends, and the first connect end having a torque spring functioning as a buffer for the connect arm, and the second and the third connect arm are respectively connected pivotally with an upper and a lower tensing roller. The first connect end is pivotally fixed on the vehicle body, and the second and the third connect ends respectively extend toward the upper and the lower portion of a chain extending around a main gear and a subordinate gear. Then the upper tensing roller located on the upper portion of the chain pushes down the upper portion of the chain, and the lower tensing roller located under the lower portion of the chain pushes upward the lower portion of the chain so that the chain is kept always tense and is prevented from falling off either of the main gear or the subordinate gear by means of the two tensing rollers, regardless of any condition of a road the vehicle may run on.

### BRIEF DESCRIPTION OF DRAWINGS

This invention will be better understood by referring to the accompanying drawings, wherein:

FIG. 1 is a structural view of a conventional chain-tensing device for an engine gear;

FIG. 2 is a first action view of the conventional chain-tensing device for an engine gear;

FIG. 3 is a second action view of the conventional chain-tensing device for an engine gear;

FIG. 4 is a perspective view of a position limit plate provided in the conventional chain-tensing device for an engine gear;

FIG. 5 is an exploded perspective view of a chain-tensing device for an engine gear in the present invention;

FIG. 6 is a side view of the chain tensing device for an engine gear in the present invention;

FIG. 7 is a side view of the chain tensing device for an engine gear in the present invention, showing it in a used condition; and,

FIG. 8 is a side view of the chain-tensing device for an engine gear in the present invention, showing it in another used condition.

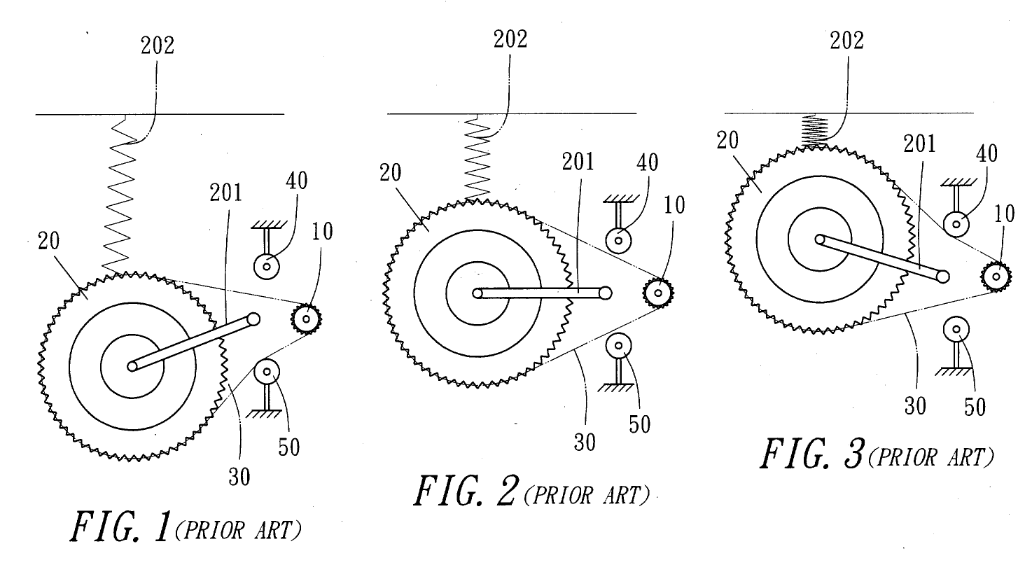

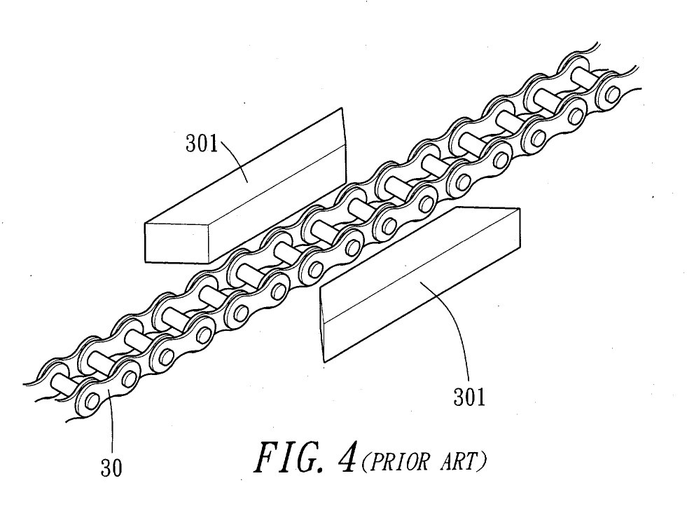

### DETAILED DESCRIPTION OF THE PREFERRED EMBODIMENT

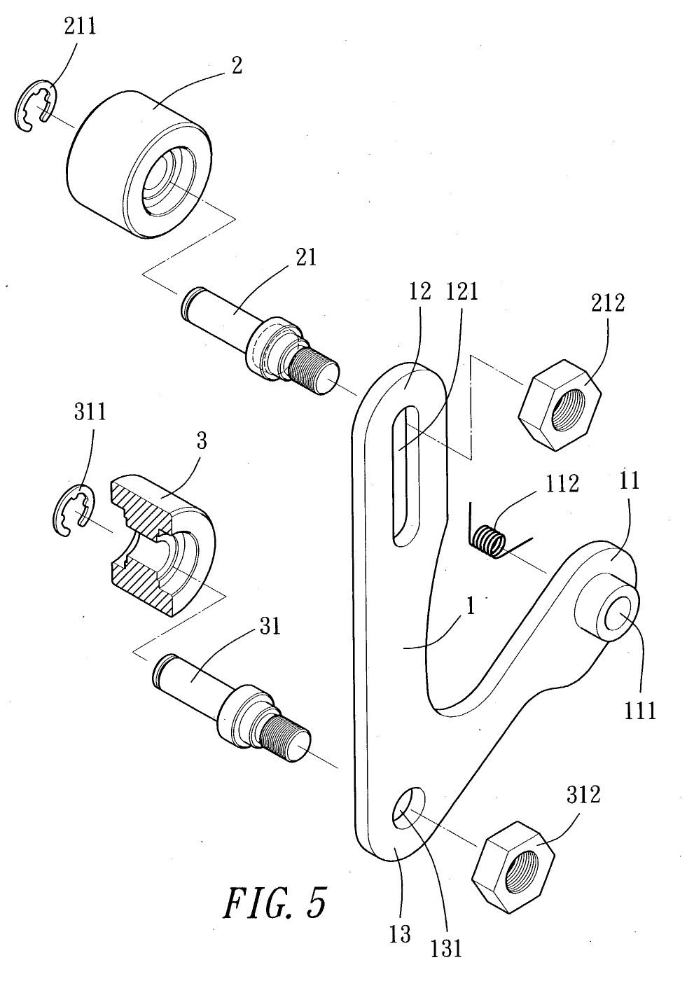

A preferred embodiment of a chain tensing device for an engine gear in the present invention, as shown in FIG. 5, includes a connect arm 1 and a pair of tension rollers—an upper one and a lower one 2, 3 as main components combined together.

The connect arm 1 is nearly L-shaped, having a first connect end 11, a second connect end 12, a third connect end 13. The first connect end 11 has a center cavity 111 for receiving a torque spring 112 therein, and the second connect end 12 has a slot 121, and the third connect end has a hole 131.

The upper and the lower tension roller 2 and 3 are respectively pivotally connected to two shafts 21, 31 by means of helical spring lock washers 211, 311 so that the upper and the lower tensing roller 21 and 31 can rotate freely on the shafts 21, 31. Further, the two shafts 21, 31 respectively pass through the slot 121 and the hole 131 of the connect arm 1, and then fixed with the connect arm 1 toward the inner side of the vehicle body by means of two nuts 212, 312.

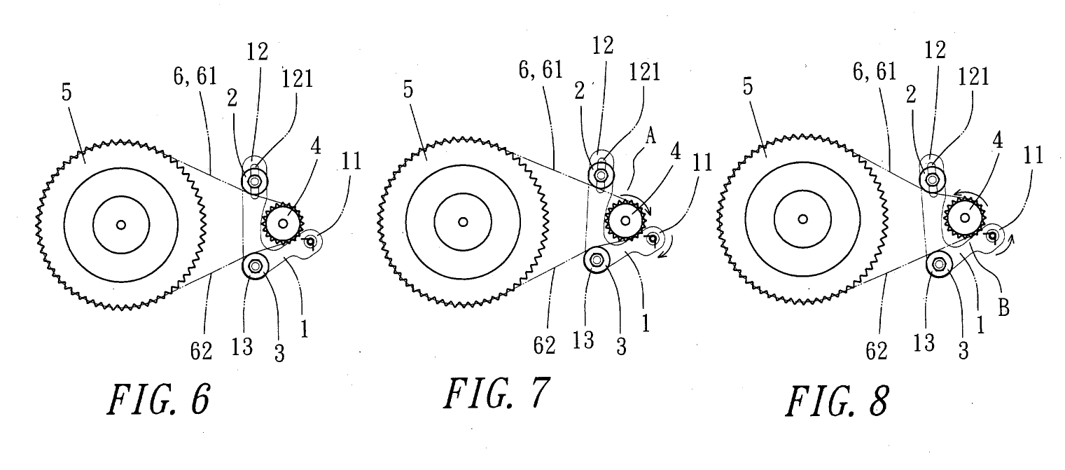

FIGS. 6 to 8 show used conditions of the chain-tensing device for an engine gear in the present invention. The connect arm 1 has its connect end 11 pivotally connected to the vehicle body near a main gear 4 as shown in FIG. 6, and the torque spring 112 functions as a buffer for supporting elastically the connect arm 1 to incline upward a litle. The two connect end 12 and 13 are located nearer to the subordinate gear 5, letting the tensing roller 2 located above the upper portion 61 of the chain 6 push down the upper portion 61 of the chain 6, and the lower roller 3 located under the lower portion 62 of the chain 6 push upward the lower portion 62 of the chain 6 so that the chain 6 has both the upper and the lower portion always kept tense

When a vehicle is running forward (with the main gear 4 has its top end A functioning as a pulling end, and with the subordinate gear 5 rotating in a clockwise direction), the upper portion of the chain 6 is in a tense condition, as shown in FIG. 7. Then the upper portion 61 of the chain 6 becomes straight so that the connect arm 1 biases upward with the first connect end 11 as a pivot, and accordingly the upper and the lower roller 2 an 3 are also pushed up a little, with the lower roller 3 pushing upward the lower portion 62 of the chain 6 to keep the chain 6 tense.

On the contrary, if the main gear 4 rotates reversely, or reduces speed (i. g. the end point B of the main gear 4 functioning as a pulling force, with the subordinate gear 5 rotating reversely; or with speed reducing the subordinate gear 5 rorating faster than the main gear 4 by dint of inertia to induce the top end A of the main gear 4 becoming loose), the lower portion 62 of the chain 6 becomes tense owing to the pulling force as shown in FIG. 8. Then the lower portion 62 of the chain 6 straightens so that the connect arm 1 biases downward with the first connect end 11 as a pivot, forcing the upper and the lower roller 2 and 3 move down a little at the same time. In this way, the upper roller 2 can also keep the upper portion 61 of the chain 6 in a tense 5 condition, and so the chain 6 can be kept tense always.

The invention has the following advantages, as can be understood from the fore said description.

1. The upper and the lower roller 2 and 3 can always push respectively the upper and the lower portion of the chain 6, regardless of any condition of a road a vehicle may run on, and the connect arm 1 can pivotally move with the first connect end 11 functioning as a pivot so that the upper and the lower roller 2 and 3 may surely push the upper and lower portion of the chain 6 regardless of clockwise or counterclockwise rotation or speed reducing of the main gear 4.

2. The torque spring 112 received in the cavity 111 of the first connect end 11 not only keeps the connect arm 1 incline upward a little, but absorbs the pulling force of the upper and the lower portion 61, 62 of the chain 6 against the connect arm 1 during increasing or reducing running speed of the vehicle so as to reduce the vibration of the connect arm 1,

3. The slot 121 of the second connect end 12 can adjust the location of the upper roller 2 depending on the tense or loose condition of the chain 6 so as to keep the chain 6 in the best condition

4. The upper and the lower roller 2 and 3 in the invention can push the upper and the lower portion 61, 62 of the chain 6 any time, preventing the chain 6 from falling off the main gear 4 and the subordinate gear 5, needless to have the position limiting plate used in the conventional device and accordingly saving its cost.

While the preferred embodiment of the invention has been described above, it will be recognized and understood that various modifications may be made therein and the appended claims are intended to cover all such modifications that may fall within the spirit and scope of the invention.

I claim:

1. A chain tensing device for an engine gear comprising a connect arm and an upper tensing roller and a lower tensing roller:
Said connect arm having three connect ends, a first one of said three connect ends provided with a torque spring functioning as buffer to elastically support said connect arm; a second one and a third one of said three connect ends respectively connected pivotally with said upper tensing roller and said lower tensing roller at their inner side so as to respectively push an upper portion and a lower portion of a chain extending around a main gear connected to an engine of a vehicle and a subordinate gear; said first connect end of said connect arm firmly and pivotally connected to the vehicle body and provided with said torque spring having a resilience of keeping said connect arm incline upward a little, said second and said third connect end extending toward said chain to force said upper tensing roller located on said upper portion of said chain push down said upper portion of said chain and said lower tensing roller located under said lower portion of said chain push up said lower portion of said chain so that said chain is pushed by said upper and said lower tensing roller at the same time, said chain always kept tense accordingly and prevented from falling off said main gear and said subordinate gear regardless of any condition of a road the vehicle may run on.

2. The chain tensing device for an engine gear as claimed in claim 1, wherein said second connect end of said connect arm has a slot for adjusting the location of said upper tensing roller.
